(19) United States
(12) Patent Application Publication
(10) Pub. No.: US 2015/0303507 A1
(43) Pub. Date: Oct. 22, 2015

(54) CATHODE FOR MOLTEN CARBONATE FUEL CELLS HAVING STRUCTURE PROVIDING NEW ELECTROCHEMICAL REACTION SITES, METHOD FOR PREPARING THE SAME, AND METHOD FOR IMPROVING CATHODE PERFORMANCE BY WETTABILITY CONTROL ON MOLTEN CARBONATE ELECTROLYTE FOR MOLTEN CARBONATE FUEL CELLS

(71) Applicant: KOREA INSTITUTE OF SCIENCE AND TECHNOLOGY, Seoul (KR)

(72) Inventors: Sung Pil YOON, Seongnam-si (KR); Suk Woo NAM, Seoul (KR); Chang Won YOON, Seoul (KR); Tae Hoon LIM, Seoul (KR); Dae Ki CHOI, Seoul (KR); Sun-Hee CHOI, Seoul (KR); Jonghee HAN, Seoul (KR); Hyung Chul HAM, Seoul (KR); Hoang Viet Phuc Nguyen, Seoul (KR)

(73) Assignee: KOREA INSTITUTE OF SCIENCE AND TECHNOLOGY, Seoul (KR)

(21) Appl. No.: 14/551,064

(22) Filed: Nov. 23, 2014

(30) Foreign Application Priority Data
Apr. 17, 2014 (KR) 10-2014-0046171

(51) Int. Cl. H01M 8/14

(52) U.S. Cl. CPC H01M 8/142; H01M 8/145; H01M 2008/147

(57) ABSTRACT

By forming a structure wherein an oxygen ionic conductor or a mixed ionic-electronic conductor (MIEC) on a cathode surface is not covered by a molten carbonate electrolyte using an oxygen ionic conductor or a mixed ionic-electronic conductor having poor wettability on the molten carbonate electrolyte, a new electrochemical reaction site may be provided in addition to that provided by the molten carbonate electrolyte. As a result, cell performance, particularly cathode performance, can be improved even at low operation temperatures (e.g., 500-600° C.).

### CROSS-REFERENCE TO RELATED APPLICATION

This application claims priority to Korean Patent Application No. 10-2014-0046171, filed on Apr. 17, 2014, and all the benefits accruing therefrom under 35 U.S.C. §119, the contents of which in its entirety are herein incorporated by reference.

### BACKGROUND

1. Field

The present disclosure relates to a cathode for a molten carbonate fuel cell having a structure providing a new electrochemical reaction site, a method for preparing the same, and a method for improving cathode performance for a molten carbonate fuel cell by wettability control on a molten carbonate electrolyte. The molten carbonate fuel cell using the cathode can be widely applied in a variety of systems including large-scale distributed generation, carbon dioxide concentration, etc.

2. Description of the Related Art

The existing cathode for a molten carbonate fuel cell is prepared by preparing a porous nickel electrode, assembling a cell and injecting a reaction gas so as to form lithiated nickel oxide (NiO) in situ.

That is to say, the porous nickel electrode included in the cell during the assembly is transformed to nickel oxide (NiO) by reacting with oxygen in air as the reaction gas during the operation of the fuel cell. At the same time, it reacts with lithium carbonate existing in an electrolyte and turns into porous lithiated nickel oxide (NiO). Although nickel oxide lacks electrical conductivity in itself, electrical conductivity increases rapidly as a result of lithiation with lithium in the electrolyte, allowing use as a cathode for a molten carbonate fuel cell.

However, the lithiated nickel oxide formed in situ as the cathode for a molten carbonate fuel cell is problematic in that the fuel cell performance is decreased greatly as compared to a theoretically possible fuel cell performance since the rate of oxygen reduction reaction in the cathode is much slower than an oxidation reaction of hydrogen in an anode.

Unlike the anode wherein nickel remains as metal, nickel is converted to nickel oxide in the cathode during the operation of the cell. Since nickel oxide has a small wetting angle (θ<10°) for commonly used molten carbonate electrolytes (Li—K carbonate, Li—Na carbonate, Li—K—Na carbonate, etc.), a film or membrane of the molten carbonate electrolyte is formed on the surface of lithiated nickel oxide (NiO). As a result, electrochemical reactions on the cathode occur on the molten carbonate electrolyte film or membrane.

Accordingly, the performance of the molten carbonate fuel cell, especially at 600° C. or below, can be determined by how well oxygen is dissolved in the molten carbonate electrolyte.

That is to say, slow oxygen reduction reaction due to low oxygen solubility and low diffusivity of the molten carbonate electrolyte, which serves as an electrochemical reaction site, and low electrochemical reaction rate of oxygen species related with cathode electrochemical reactions (e.g., superoxide (O₂⁻), peroxide (O₂²⁻), etc.) at low operation temperature (550-650° C., especially at 600° C. or below) is the major cause of decreased performance of the existing molten carbonate fuel cell.

Meanwhile, since the molten carbonate fuel cell is operated at 650° C. using a molten salt (Li/K carbonate, Li/Na carbonate, Li/K/Na carbonate, etc.) as an electrolyte, electrolyte loss occurs as a result of corrosion, creepage, evaporation, etc. and long-term operation is restricted thereby.

Although many methods to reduce the corrosion or creepage have been developed, the only known solution to the evaporation problem is to decrease operation temperature or develop a new electrolyte exhibiting less evaporation loss.

Recently, a method of lowering operation temperature from 650° C. to around 620° C. has been developed to improve the operation life of the molten carbonate fuel cell. For example, the Fuel Cell Energy (FCE, US) has improved the molten carbonate fuel cell stack life from around 20,000 hours to nearly 40,000 hours by lowering the operation temperature to 620° C. In addition, the FCE is conducting researches on improving the stack life to longer than 70,000 hours by lowering the operation temperature of the molten carbonate fuel cell stack below 580° C.

The FCE could lower the operation temperature of the molten carbonate fuel cell from 650° C. to 620° C. by changing the electrolyte from Li—K carbonate to Li—Na carbonate.

Since Li—Na carbonate electrolyte has a carbonate ion (CO₃²⁻) conductivity of 1.75 S/cm at operation temperatures, which is higher than that of Li—K carbonate electrolyte (1.15 S/cm), and exhibits less dissolution of Ni to NiO in the electrolyte, many studies have been made as an alternative electrolyte material. However, because of low oxygen solubility as compared to Li—K carbonate, Li—Na carbonate is known to exhibit high cathode polarization at low operation temperatures.

Recently, D. Kaun et al. have patented the improvement of cell performance by adding Ba or Sr to Li—Na carbonate electrolyte (U.S. Pat. No. 5,942,345; patent document 1). As a result of improving the oxygen solubility of the Li—Na carbonate electrolyte, high cell performance is achieved at operation temperatures of 600° C. or above.

Also, S. Frangini et al. have reported that cathode and cell performance can be improved by improving oxygen solubility by adding additives to Li—K or Li—Na carbonate electrolyte [Journal of The Electrochemical Society, 151 (8) A1251-A1256 (2004); non-patent document 1].

However, despite the mixing with the additives, both the Li—K and Li—Na carbonate electrolytes are reported to exhibit significant performance decrease at operation temperatures of 600° C. or lower because of an increase of cathode polarization, in particular, polarization due to oxygen-related electrochemical reactions.

In this regard, the improvement in cell performance at operation temperatures of 550-600° C. (or 500-600° C.) is important because decreased overall operation temperature requires longer operation time and, for this, the improvement in cell performance is necessary. In addition, since the significant performance decrease in the low temperature range owing to the temperature difference in the stack is accompanied by nonuniform electrochemical reactions in the stack and undesired stack durability due to temperature nonuniformity, etc., the improvement in cell performance at operation temperatures of 550-600° C. (or 500-600° C.) is important.

Recently, the FCE has reported in U.S. Pat. No. 8,557,486 (patent document 2) an improvement in performance by at least 0.8 V under the condition of 160 mA/cm² by adding Rb_{2C}O₃, Cs_{2C}O₃, BaCO₃, La₂O₃, Bi₂O₃, Ta₂O₃ or a mixture thereof to Li/K or Li/Na molten carbonate electrolyte and, thereby, reducing cathode polarization at operation temperatures of 575-600° C. According to the patent document 2, it is described that the additives reduce cathode polarization by increasing oxygen solubility of the molten carbonate electrolyte even at low operation temperatures.

However, according to the studies conducted by the inventors of the present disclosure, this method is also limited in that the improvement in the oxygen solubility of the molten carbonate electrolyte is dependent on the electrochemical reaction site of the molten carbonate electrolyte. Moreover, depending on additives, the improvement in the oxygen solubility of the molten carbonate electrolyte may be not sufficient. For example, Bi₂O₃ does not lead to significant improvement in solubility for L/K molten carbonate electrolyte unlike other carbonates [less than 0.3 mol % under the condition of 650° C., 1 atm and CO₂ atmosphere, Journal of The Electrochemical Society, 146 (7) 2449-2454 (1999), Catalysis Today, 148 303-309 (2009); non-patent documents 2-3]. As such, the improvement in the oxygen solubility of the molten carbonate electrolyte by adding additives to the molten carbonate electrolyte is restricted since, for example, long-term stability is not ensured due to the additives are not stabilized because of the problems of deposition, corrosion, etc.

### REFERENCES OF THE RELATED ART

### Patent Documents

U.S. Pat. No. 5,942,345
U.S. Pat. No. 8,557,468

### Non-patent Documents

S. Frangini and S. Scaccia, Journal of the Electrochemical Society, 151 (8) A1251-A1256 (2004)
Li Qingfeng, et. al., Journal of the Electrochemical Society, 146 (7) 2449-2454 (1999)
Yongdan Li, et. al., Catalysis Today, 148 303-309 (2009)
Journal of Materials Science, 36 1271-1276 (2001)

### SUMMARY

The inventors of the present disclosure have noted that the existing method of improving the performance of a molten carbonate fuel cell by increasing the oxygen solubility of the molten carbonate electrolyte is limited and have conducted researches to provide a fundamental solution thereto.

The present disclosure is directed to providing a structure of a cathode for a molten carbonate fuel cell, capable of providing a new electrochemical reaction site in addition to the electrochemical reaction sites provided by the existing molten carbonate fuel cell cathode and molten carbonate electrolyte by wettability control on the molten carbonate electrolyte, a method for preparing the same, and a method for improving cathode performance by wettability control on a molten carbonate electrolyte for a molten carbonate fuel cell.

The present disclosure is also directed to providing a molten carbonate anode cathode capable of ensuring physical and chemical stability of a molten carbonate electrolyte at low operation temperatures (e.g., 500-650° C., specifically at 600° C. or lower), and, in particular, exhibiting comparable or better cell performance as compared to the existing cathode electrode at low operation temperatures of 600° C. or lower, a method for preparing the same, and a method for improving cathode performance by wettability control on a molten carbonate electrolyte for a molten carbonate fuel cell.

In one aspect, the present disclosure provides a cathode for a molten carbonate fuel cell, wherein a first structure and second structure are formed on the cathode,

the surface of the second structure is exposed at least partly without being covered by a material of the first structure, the first structure includes a molten carbonate electrolyte, the second structure includes an oxygen ionic conductor, a mixed oxygen ionic-electronic conductor or a combination thereof, the first structure provides a first electrochemical reaction site, and the second structure whose surface is exposed at least partly without being covered by the first structure provides a second electrochemical reaction site which is different from the first electrochemical reaction site provided by the first structure.

In an exemplary embodiment, the second structure provides an electrochemical reaction site wherein carbonate ion can be produced by an oxygen ionic conductor or a mixed oxygen ionic-electronic conductor.

In an exemplary embodiment, the second structure may include a mixed oxygen ionic-electronic conductor.

In an exemplary embodiment, the first structure is in contact with the second structure.

In an exemplary embodiment, a reaction according to [Reaction Formula 1] occurs in a portion where the first structure is in contact with the second structure and a reaction according to [Reaction Formula 2] occurs in a portion of the second structure exposed without being in contact with the first structure:

CO₂+O²⁻→CO₃²⁻ [Reaction Formula 1]

½O₂+2e⁻→O²⁻ [Reaction Formula 2]

In an exemplary embodiment, a first structure material and a second structure material are selected such that the first structure material in liquid state does not cover the second structure material in solid state under the condition of the operation temperature and cathode atmosphere of a molten carbonate fuel cell [i.e., they are selected such that the first structure material in liquid state has low wettability (or large wetting angle) on the second structure material in solid state].

In an exemplary embodiment, the first structure material in liquid state has a wetting angle (θ) of specifically 20° or greater, more specifically 50° or greater, most specifically 60-90°, on the second structure material in solid state under the condition of 500-650° C. and atmosphere of air:CO₂=70%:30%.

In an exemplary embodiment, the molten carbonate electrolyte is Li—K molten carbonate electrolyte, Li—Na molten carbonate electrolyte or Li—K—Na molten carbonate electrolyte.

In an exemplary embodiment, the oxygen ionic conductor or the mixed oxygen ionic-electronic conductor includes specifically a bismuth oxide composition including bismuth oxide, doped bismuth oxide (e.g. Bi₂O₃ doped with a trivalent, tetravalent, pentavalent or hexavalent cation) or a combination thereof, more specifically doped bismuth oxide.

In an exemplary embodiment, the oxygen ionic conductor or the mixed oxygen ionic-electronic conductor is a composition including Bi₂O₃-MO (wherein M is Ca, Sr, Ba, Cu, etc.), Bi₂O₃-MO₂ (wherein M is Ti, Zr, Te, etc.), Bi₂O₃-MO₃ (wherein M is W, Mo, etc.), Bi₂O₃-M₂O₅ (wherein M is V, Nb, Ta, etc.), Bi₂O₃-M₂O₃ (wherein M is La, Sm, Y, Gd, Er, etc.) or a combination thereof as a doped bismuth oxide.

In an exemplary embodiment, the cathode is nickel or lithiated nickel oxide, specifically porous nickel or porous lithiated nickel oxide.

In another aspect, the present disclosure provides a method for preparing a cathode for a molten carbonate fuel cell, wherein a first structure and second structure are formed on the cathode, the first structure includes a molten carbonate electrolyte, the second structure includes an oxygen ionic conductor, a mixed oxygen ionic-electronic conductor or a combination thereof, the surface of the second structure is exposed at least partly without being covered by the first structure, the first structure provides a first electrochemical reaction site, and the second structure whose surface is exposed at least partly without being covered by the first structure provides a second electrochemical reaction site which is different from the first electrochemical reaction site provided by the first structure.

In an exemplary embodiment, the method includes: a first step of forming the second structure on a part of the surface of the cathode; and a second step of forming the first structure by providing a molten carbonate electrolyte as a first structure material to the cathode having the second structure formed.

In an exemplary embodiment, in the first step, the second structure may be formed by coating a second structure material including an oxygen ionic conductor, a mixed oxygen ionic-electronic conductor or a combination thereof partly on the surface of the cathode.

In an exemplary embodiment, in the first step, the second structure may be formed partly on the surface of the cathode by mixing a second structure material powder including an oxygen ionic conductor, a mixed oxygen ionic-electronic conductor or a combination thereof with a cathode material powder and sintering (e.g., in-situ sintering) the same.

In an exemplary embodiment, in the second step, the first structure may be formed by providing a molten carbonate electrolyte in solid state to the cathode having the second structure formed and operating the molten carbonate fuel cell including the cathode at an operation temperature in situ to melt the molten carbonate electrolyte in solid state into liquid state. The wettability (degree of wetting) of the molten carbonate electrolyte in liquid state on the second structure material in solid state may be controlled such that the molten carbonate electrolyte in liquid state does not cover the second structure material in solid state.

In an exemplary embodiment, in the first step, the second structure is formed by coating slurry in which a second structure material powder including an oxygen ionic conductor, a mixed oxygen ionic-electronic conductor or a combination thereof is dispersed in a solvent partly on the surface of a porous nickel cathode. In the second step, a molten carbonate electrolyte in solid state is provided to the porous nickel cathode having the second structure formed and the molten carbonate fuel cell including the cathode is operated at an operation temperature in situ. As a result, the molten carbonate electrolyte in solid state is melted into liquid state and the first structure is formed on the surface of the cathode [a cathode structure in which the first structure material does not cover the second structure is formed by controlling the wettability (degree of wetting) of the molten carbonate electrolyte in liquid state]. And the porous nickel cathode is transformed into a porous lithiated nickel oxide cathode.

In accordance with the present disclosure, since the site of oxygen reduction reaction occurring at the cathode can be extended from the molten carbonate electrolyte film or membrane (first structure) to the oxygen ionic conductor or mixed oxygen ionic-electronic conductor (second structure) not covered by the molten carbonate electrolyte, polarization resistance occurring at the cathode can be reduced and cell performance can be improved even at low operation temperatures (e.g., 500-600° C., especially 600° C. or lower). Further, the low operation temperature allows extension of the operation life of the molten carbonate fuel cell (for example, the operation life can be improved remarkably to 70,000 hours or longer).

A molten carbonate fuel cell using such a cathode can solve the problems of operation life and cost at the same time, which are the biggest obstacles in commercialization of the molten carbonate fuel cell.

### BRIEF DESCRIPTION OF THE DRAWINGS

FIG. 1A schematically shows a microstructure of a molten carbonate fuel cell cathode (wherein the surface of a second structure is exposed without being covered by a first structure) according to an exemplary embodiment of the present disclosure.

FIG. 1B schematically shows a molten carbonate electrolyte as a comparison to an embodiment of the present disclosure, wherein a first structure covers a second structure.

FIGS. 2A-2E schematically describe the Young equation for measuring wettability (FIG. 2A) and shows images showing measurement of wetting angles (θ) for different molten carbonate electrolytes [FIG. 2B: NiO cathode material, FIG. 2C: BYS (as an example of an oxygen ionic conductor or a mixed conductor with poor wettability), FIG. 2D: PbO (as an example of a non-oxygen ionic conductor or a non-mixed conductor with poor wettability), FIG. 2E: SDC (as an example of an oxygen ionic conductor or a mixed conductor with large wettability)] [measurement condition: temperature=500-650° C.; cathode atmosphere, air:CO₂=70%:30%; molten carbonate electrolyte=62 mol % Li₂CO₃:38 mol % K₂CO₃].

FIG. 3 shows a graph illustrating a result of forming an electrode microstructure as shown in FIG. 1A using 0 wt %, 5.7 wt % and 9.5 wt % (based on Ni weight of cathode) of Bi_{1.5}Y_{0.3}Sm_{0.2}O₃ (hereinafter, BYS) as an oxygen ionic conductor or a mixed oxygen ionic-electronic conductor with poor wettability on a molten carbonate electrolyte on the inner surface of a molten carbonate fuel cell cathode and measuring the performance of a 100 cm² unit cell at different operation temperatures in Test Example 1 (power density measured at 650° C., 600° C. and 550° C. after operation at 650° C. for 288 hours; cathode, air:CO₂=70%:30%; anode, H₂:CO₂:H₂O=72%:18%:10%; oxygen and hydrogen utilization factor=40%).

FIG. 4 shows a graph illustrating a result of forming an electrode microstructure as shown in FIG. 1A using 2.8 wt % or 9 wt % (based on Ni weight of cathode) of BYS as an oxygen ionic conductor or a mixed conductor with poor wettability on the inner surface of a molten carbonate fuel cell cathode and measuring the long-term performance of a 100 cm² unit cell for 2,000 hours at 550° C. under the current density of 150 mA/cm² in Test Example 1 (operation temperature=550° C.; cathode, air:CO₂=70%:30%; anode H₂:CO₂:H₂O=72%:18%:10%, oxygen and hydrogen utilization factor=40%).

FIG. 5 shows a graph illustrating a result of forming an electrode microstructure as shown in FIG. 1A using 10 wt % (based on Ni weight of cathode) of Bi_{1.8}Sm_{0.2}O₃ (BSO) as a mixed oxygen ionic-electronic conductor with poor wettability on a molten carbonate electrolyte on the inner surface of a molten carbonate fuel cell cathode and measuring the performance of a 100 cm² unit cell at different operation temperatures in Test Example 2 (power density measured at 650° C., 600° C., 550° C., 520° C. and 500° C. after operation at 650° C. for 288 hours; cathode, air:CO₂=70%:30%; anode, H₂:CO₂:H₂O=72%:18%:10%; oxygen and hydrogen utilization factor=40%).

FIG. 6 shows a graph illustrating a result of analyzing phase change by XRD after immersing BYS powder in 62 mol % Li₂CO₃:38 mol % K₂CO₃ molten carbonate under the atmosphere of air:CO₂=70%:30% for at least 100 hours (out-of-cell test) in order to investigate the phase stability of the BYS powder used in Test Example 1 in a molten carbonate electrolyte.

FIG. 7 shows a graph illustrating a result of forming an electrode microstructure as shown in FIG. 1A using 10 wt % (based on Ni weight of cathode) of PbO as a non-oxygen ionic conductor or a non-mixed conductor with poor wettability on a molten carbonate electrolyte on the inner surface of a molten carbonate fuel cell cathode and measuring the performance of a 100 cm² unit cell at different operation temperatures in Test Example 3 (power density measured at 650° C., 600° C. and 550° C. after operation at 650° C. for 100 hours; cathode, air:CO₂=70%:30%; anode, H₂:CO₂:H₂O=72%:18%:10%; oxygen and hydrogen utilization factor=40%).

FIG. 8 shows a graph illustrating a result of forming an electrode microstructure as shown in FIG. 1A using 10 wt % (based on Ni weight of cathode) of SDC as an oxygen ionic conductor or a mixed conductor with good wettability on a molten carbonate electrolyte on the inner surface of a molten carbonate fuel cell cathode and measuring the performance of a 100 cm² unit cell at different operation temperatures in Test Example 4 (power density measured at 550° C. as compared to the existing NiO electrode cell and a Bi₂O₃-coated electrode cell (power density measured at 550° C. after operation for 100 hours; cathode, air:CO₂=70%:30%; anode, H₂:CO₂:H₂O=72%:18%:10%; oxygen and hydrogen utilization factor=40%).

FIG. 9 shows a graph illustrating a result of forming an electrode microstructure as shown in FIG. 1A using 10 wt % (based on Ni weight of cathode) of pure bismuth oxide as an oxygen ionic conductor or a mixed conductor with poor wettability on a molten carbonate electrolyte on the inner surface of a molten carbonate fuel cell cathode and measuring the performance of a 100 cm² unit cell at different operation temperatures in Test Example 5 (power density measured at 650° C., 600° C. and 550° C. after operation at 650° C. for 100 hours; cathode, air:CO₂=70%:30%; anode, H₂:CO₂:H₂O=72%:18%:10%; oxygen and hydrogen utilization factor=40%).

### DETAILED DESCRIPTION

Hereinafter, exemplary embodiments of the present disclosure are described in detail.

In the present disclosure, a mixed conductor (mixed ionic-electronic conductor, MIEC) refers to a conductor that can conduct both oxygen ions and electrons, i.e., a material that has oxygen ionic conductivity and electronic conductivity at the same time.

In the present disclosure, an electrochemical reaction site refers to a site where oxygen can combine with carbon dioxide to generate a carbonate ion.

In the present disclosure, an oxygen vacancy refers to an empty oxygen site in a crystal lattice of an oxygen ionic conductor or a mixed oxygen ionic-electronic conductor exhibiting oxygen ionic conductivity.

In the present disclosure, formation of a first structure and a second structure on a cathode includes not only the formation of a first structure and a second structure on the outer surface of a cathode but also the formation of a first structure and a second structure on an inner surface of a porous cathode material having pores therein (it may be called a porous surface). Since pores are formed by porous materials such as porous nickel inside a porous cathode and air is in contact with the pores, a first structure and a second structure may be also formed on the inner surface of the porous cathode.

If a cathode for a molten carbonate fuel cell is surface-treated with a material which is not easily wet with a molten carbonate electrolyte [a material having a large wetting angle on a (solid) material of the liquid molten carbonate electrolyte], cathode performance can be improved even in the operation temperature regions where the oxygen solubility and the diffusion rate of oxygen species into the molten carbonate electrolyte become low (e.g., 500-650° C. or 500-620° C., specifically 500-600° C. or 550-600° C.). As a surface-treating material, an oxygen ionic conductor or a mixed conductor (mixed ionic-electronic conductor, MIEC; i.e., a material having oxygen ionic conductivity and electronic conductivity at the same time) which is physically and chemically stable with respect to the molten carbonate electrolyte at the operation temperature of the molten carbonate fuel cell and has poor wettability is used. As a result, a novel cathode structure that provides a new electrochemical reaction site (a new electrochemical reaction site capable of generating a carbonate ion through reaction with the oxygen ionic conductor or the mixed oxygen ionic-electronic conductor in addition to an electrochemical reaction site provided by the molten carbonate electrolyte) without being covered by the molten carbonate electrolyte may be provided. Detailed description is given hereinbelow.

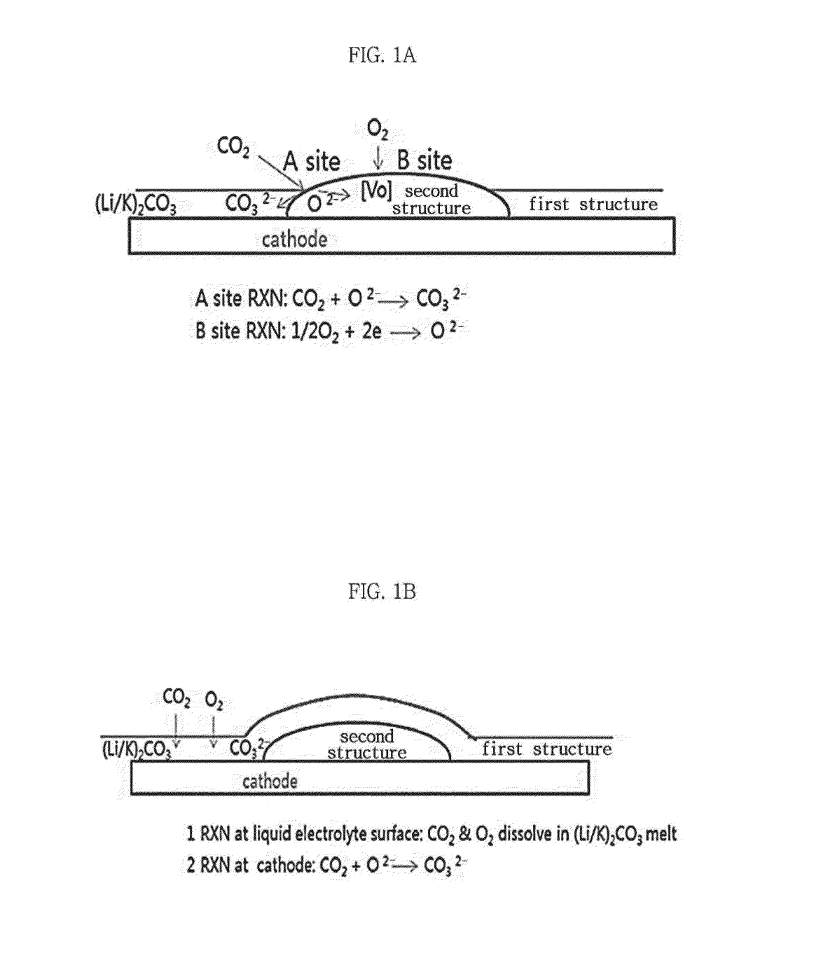

FIG. 1A schematically shows a microstructure of a molten carbonate fuel cell cathode according to an exemplary embodiment of the present disclosure.

As seen from FIG. 1A, a cathode structure according to an exemplary embodiment of the present disclosure has a first structure formed of a molten carbonate electrolyte and providing a first electrochemical reaction site and a second structure not covered by the first structure, on a cathode surface (outer surface and/or inner surface of a cathode).

Specifically, the first structure and the second structure may be in contact with each other. That is to say, in an exemplary embodiment, a first structure material (molten carbonate electrolyte), the cathode surface and a second structure material (an oxygen ionic conductor or a mixed oxygen ionic-electronic conductor) are in contact with each other and the surface of the second structure material is at least partly exposed toward air, as shown in FIG. 1A.

The molten carbonate electrolyte forming the first structure dissolves carbon dioxide and oxygen and provides them to the cathode. As a result, a carbonate ion is produced. That is to say, an existing electrochemical reaction site for the reaction CO₂+½O₂+2e=CO₃²⁻ is provided at the interface between the first structure and the electrode. And, an additional electrochemical reaction site for the reaction CO₂+O²⁻=CO₃²⁻ is provided at the interface between the first structure and the second structure.

The second structure is formed of an oxygen ionic conductor, a mixed oxygen ionic-electronic conductor or a combination thereof. The second structure is at least partly exposed to air (oxygen) without being covered by the first structure.

As such, an additional electrochemical reaction site (second electrochemical reaction site) different from a first electrochemical reaction site may be provided at the interface between the second structure and the first structure. In addition, the second structure exposed to air allows generation of an oxygen ion through the reaction ½O₂+2e=O²⁻, allowing continuous electrochemical reactions at the interface between the first structure and the second structure.

That is to say, being directly exposed to air (oxygen), the second structure may provide a site for providing oxygen and allow transfer of an oxygen ion and/or an electron to produce a carbonate ion. The production of the carbonate ion by the second structure follows a new electrochemical reaction route different from the production of carbonate ion at the first structure.

More specifically, the electrochemical reaction by the second structure may be divided into a reaction occurring at the contact of the second structure and the molten carbonate electrolyte (A site, i.e., the interface between the first structure and the second structure) and a reaction occurring on the surface of the second structure exposed to oxygen in air without being in contact with the molten carbonate electrolyte (B site, i.e., the surface of the second structure exposed to air).

Carbonate is produced at the A site according to [Reaction Formula 1], and oxygen ion is produced at the B site according to [Reaction Formula 2].

CO₂+O²⁻→CO₃²⁻ [Reaction Formula 1]

½O₂+2e⁻→O²⁻ [Reaction Formula 2]

In the light of oxygen vacancy, [Reaction Formula 1] and [Reaction Formula 2] may be represented by [Reaction Formula 1-1] and [Reaction Formula 1-2].

CO₂+O²⁻→CO₃²⁻+V_{O} (generation of oxygen vacancy site) [Reaction Formula 1-1]

½O₂+2e⁻+V_{O}→O_{O}^{X} (extinction of oxygen vacancy site) [Reaction Formula 2-1]

A oxygen vacancy generated site at the A site (see [Reaction Formula 1-1]) moves to the B site and is extinguished by reacting with an oxygen ion (see [Reaction Formula 2-1]). As a result, the overall mass valance of the oxygen ionic conductor or the mixed oxygen ionic-electronic conductor can be maintained.

Considering these factors, a mixed conductor generating oxygen ions and electrons (holes) at the same time is preferred to a pure oxygen ionic conductor.

If the second structure is not formed or, even if the second structure is formed of an oxygen ionic conductor or a mixed oxygen ionic-electronic conductor and the second structure is covered by the first structure, the new electrochemical reaction route described above cannot be provided (see test examples described below).

FIG. 1B schematically shows a molten carbonate electrolyte as a comparison to an embodiment of the present disclosure, wherein a first structure covers a second structure.

As seen from FIG. 1B, if a molten carbonate electrolyte film or membrane forming the first structure covers the second structure formed of an oxygen ionic conductor, a mixed oxygen ionic-electronic conductor or a combination thereof, the second structure cannot be in contact with air (oxygen). As a result, the second electrochemical reaction described above cannot occur and only the first electrochemical reaction by the first structure occurs.

In contrast, if the second structure is not covered by the first structure, the new electrochemical reaction route can be provided. Accordingly, since the electrochemical reaction is not dependent only on the molten carbonate electrolyte (the same is true of the case wherein an additive is dissolved in the molten carbonate electrolyte), superior cell performance can be achieved even at an operation temperature where oxygen solubility and diffusion rate of oxygen species into the molten carbonate electrolyte become low (e.g., 500-600° C.). Such a cathode structure solves the problems of low oxygen solubility and diffusion of oxygen species of the existing molten carbonate fuel cell cathode.

The molten carbonate electrolyte of the first structure is solid at room temperature but is melted and changed to liquid state at the operation temperature. The wettability (degree of wetting) of the molten carbonate electrolyte in liquid state on the second structure (solid) is controlled such that the molten carbonate electrolyte in liquid state does not cover the second structure (solid).

That is to say, the first structure material and the second structure material are selected such that the first structure material in liquid state has a predetermined wetting angle on the second structure material in solid state so that the first structure material in liquid state does not cover the second structure material in solid state (i.e., the wettability of the molten carbonate electrolyte in liquid state on the oxygen ionic conductor or mixed oxygen ionic-electronic conductor as the second structure material is as low as possible).

In an exemplary embodiment, the first structure material and the second structure material are selected such that the first structure material in liquid state has a wetting angle (θ) of specifically 20° or greater, more specifically 50° or greater, further more specifically 60° or greater, most specifically 60-90°, on the second structure material (solid) at 500-650° C. under the atmosphere of air:CO₂=70%:30%.

If the wetting angle is smaller than 20°, the first structure covers the second structure as shown in FIG. 1B and the electrochemical reaction by the first structure (molten carbonate electrolyte film or membrane) becomes dominant. As a result, it is difficult to expect improvement of electrode polarization and cell performance. In contrast, if the wetting angle is specifically 20° or greater, more specifically 50° or greater, further more specifically 60-90°, the surface of the second structure may be exposed without being covered by the first structure as shown in FIG. 1A. If the wetting angle exceeds 90°, the liquid molten carbonate electrolyte may not be able to cover the cathode surface since it cannot move toward the cathode.

In this regard, the determination of the wetting angle is well known in the related art.

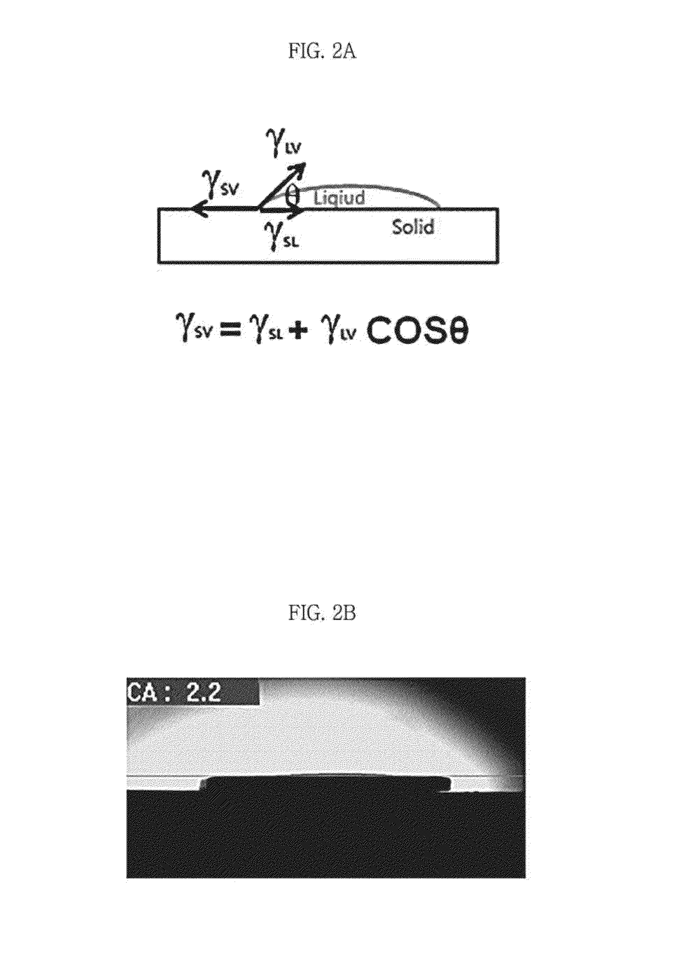

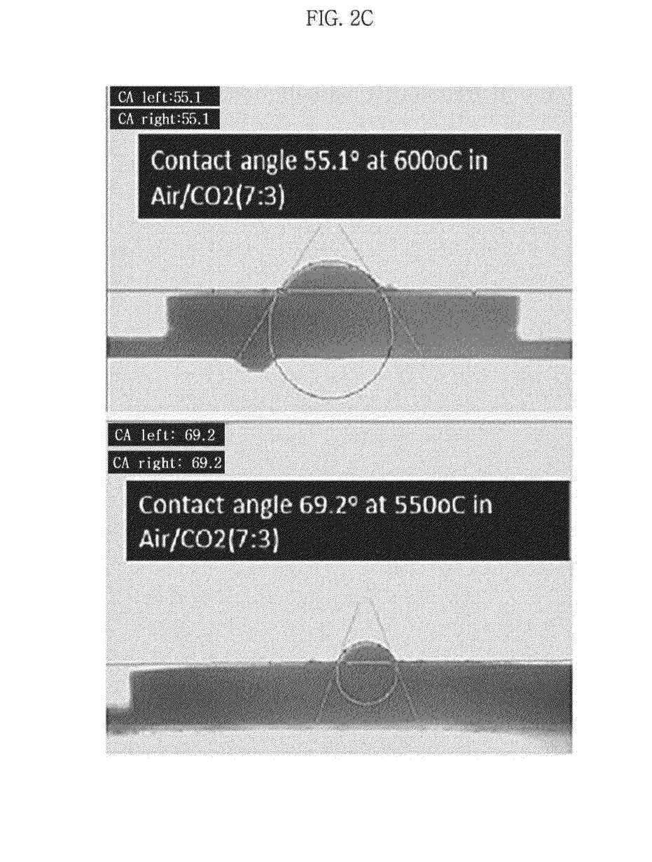

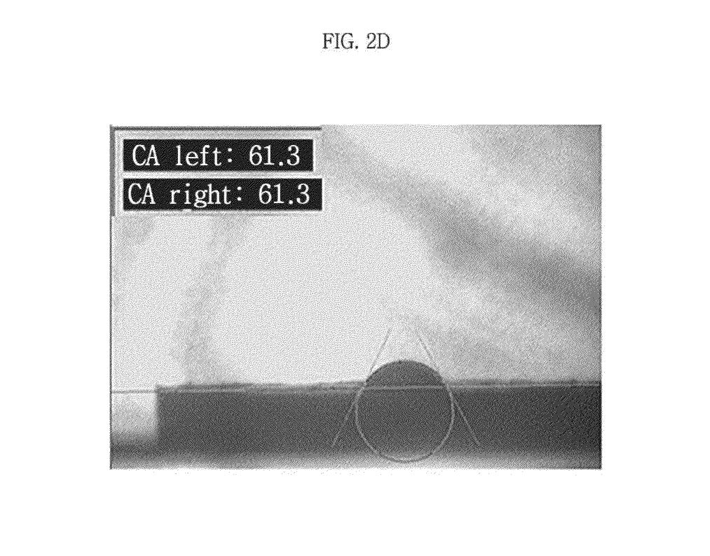

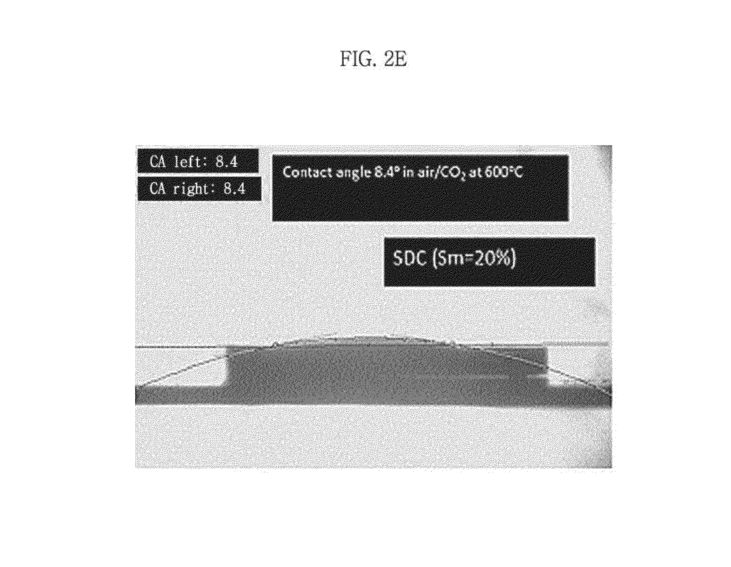

FIG. 2A describes the factors that determine the wetting angle. As seen from FIG. 2A, the wetting angle may be determined by the surface energy (surface tension) at the gas/liquid/solid interfaces according to the Young equation.

γ_{SV}=γ_{SL}+γ_{LV} cos θ [Equation 1]

[wherein γ_{SV} is the surface energy at the solid/gas interface, γ_{SL} is the surface energy at the solid/liquid interface, γ_{LV} is the surface energy at the liquid/gas interface, and θ is the wetting angle]

That is to say, the lower the surface energy of the solid, the worse is the wettability on the liquid (i.e., larger wetting angle).

In general, a wetting angle (θ) smaller than 20° is called good wettability. A wetting angle of 20° or greater can be described as moderate wettability. A wetting angle of 50° or greater can be described as poor wettability. A wetting angle of 60° or greater can be described as very poor wettability. And, a wetting angle greater than 90° can be described as non-wettable.

FIGS. 2B-2E are images showing measurement of wetting angles (θ) for different molten carbonate electrolytes as non-limiting examples [FIG. 2B: NiO cathode material, FIG. 2C: BYS (as an example of an oxygen ionic conductor or a mixed conductor with poor wettability), FIG. 2D: PbO (as an example of a non-oxygen ionic conductor or a non-mixed conductor with poor wettability), FIG. 2E: SDC (as an example of an oxygen ionic conductor or a mixed conductor with large wettability)] [measurement condition: temperature=500-650° C.; cathode atmosphere, air:CO₂=70%:30%; molten carbonate electrolyte=62 mol % Li₂CO₃:38 mol % K₂CO₃].

In FIGS. 2B-2E, the bottommost part is a sample holder, the rectangular part thereon is each material, and the part thereon is a molten carbonate electrolyte.

FIG. 2B shows a result of measuring the wetting angle (θ) of a 62 mol % Li₂CO₃: 38 mol % K₂CO₃ molten carbonate electrolyte on a general NiO cathode material at 600° C. under the atmosphere of air:CO₂=70%:30%. The molten carbonate electrolyte (liquid electrolyte) exhibits high wettability on the NiO (solid) with a wetting angle (θ) of 2.2° or smaller.

FIG. 2C shows a result of measuring the wetting angle (θ) on BYS under the same condition. The molten carbonate electrolyte (liquid electrolyte) exhibits poor wettability on the BYS (solid) with wetting angles (θ) of 55.1° at 600° C. and 69.2° at 550° C.

FIG. 2D shows a result of measuring the wetting angle (θ) on PbO (lacking oxygen ionic conductivity) which is well known not to get wet by the molten carbonate electrolyte under the same condition. The molten carbonate electrolyte (liquid electrolyte) exhibits poor wettability on the PbO (solid) with a wetting angle (θ) of 61.3° at 650° C.

FIG. 2E shows a result of measuring the wetting angle (θ) on samarium-doped ceria (SDC) under the same condition. The molten carbonate electrolyte (liquid electrolyte) exhibits high wettability on the SDC with a wetting angle (θ) of 8.4° or smaller at 600° C.

As described above, in the embodiments of the present disclosure, by forming the microstructure of the second structure which is not covered by the molten carbonate electrolyte (liquid electrolyte) on the cathode surface as shown in FIG. 1A using a second structure material with poor wettability on which the liquid molten carbonate electrolyte has a wetting angle (θ) of 20° or greater, more specifically 50° or greater, more specifically 60-90°, (i.e., an oxygen ionic conductor, a mixed oxygen ionic-electronic conductor or a combination thereof with poor wettability), the operation life of the molten carbonate fuel cell can be greatly improved (e.g., 70,000 hours or longer) while allowing operation at low temperatures of 600° C. or lower as compared to the existing molten carbonate fuel cell.

As a non-limiting example, a previously known molten carbonate electrolyte may be used as the molten carbonate electrolyte. For example, a Li—K molten carbonate electrolyte, a Li—Na molten carbonate electrolyte or a Li—K—Na molten carbonate electrolyte may be used.

As a non-limiting example, the oxygen ionic conductor or the mixed oxygen ionic-electronic conductor may be a bismuth oxide composition including bismuth oxide, doped bismuth oxide (e.g., Bi₂O₃ doped with a trivalent, tetravalent, pentavalent or hexavalent cation) or a combination thereof, although not being particularly limited thereto.

Especially, doped bismuth oxide is preferred for the second structure providing the second electrochemical reaction site since it exhibits better oxygen ionic conductivity, etc. than pure bismuth oxide.

Specifically, the oxygen ionic conductor or the mixed oxygen ionic-electronic conductor may be a composition including Bi₂O₃-MO MO (wherein M is one or more of Ca, Sr, Ba, Cu, etc.), Bi₂O₃-MO₂ (wherein M is one or more of Ti, Zr, Te, etc.), Bi₂O₃-MO₃ (wherein M is one or more of W, Mo, etc.), Bi₂O₃-M₂O₅ (wherein M is one or more of V, Nb, Ta, etc.), Bi₂O₃-M₂O₃ (wherein M is one or more of La, Sm, Y, Gd, Er, etc.) or a combination thereof as a doped bismuth oxide.

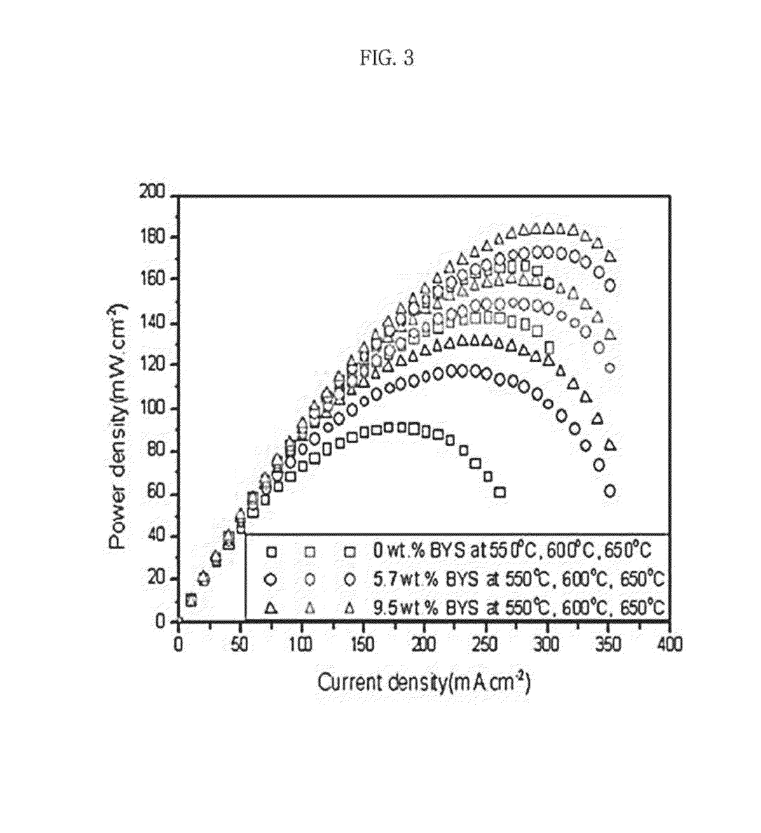

As a non-limiting example, bismuth oxide or doped bismuth oxide having poor wettability (e.g., a wetting angle of 60-90° at 600° C. under the atmosphere of air:CO₂=70%:30%) for the molten carbonate electrolyte may be formed on the porous lithiated nickel oxide cathode surface (outer surface and/or inner surface) to significantly reduce cathode polarization. For example, whereas the lithiated nickel oxide electrode alone exhibits power densities of 165 mW/cm² (or 90 mW/cm²) at 650° C. (or 550° C.) under the operation condition of air and hydrogen, the lithiated nickel oxide cathode having the second structure of doped bismuth oxide (Bi_{1.5}Y_{0.3}Sm_{0.2}O₃) formed exhibits power densities of 185 mW/cm² (or 132 mW/cm²) under the same condition (see FIG. 2). Also, a long-term stability test shows that it can be operated stably for 2000 hours without degradation of performance (see FIG. 3).

In an exemplary embodiment of the present disclosure, the cathode having the first structure and the second structure may be nickel, specifically porous nickel. Also, after assembling a cell using a nickel electrode, a reaction gas may be injected to transform the nickel into porous lithiated nickel oxide (NiO) in situ. Accordingly, in an exemplary embodiment of the present disclosure, the cathode having the first structure and the second structure may be specifically porous lithiated nickel oxide.

In an embodiment of the present disclosure, the molten carbonate fuel cell cathode having the first structure and the second structure may be prepared as follows.

After forming the second structure on a part of the surface of the cathode (first step), the first structure may be formed by providing a molten carbonate electrolyte as a first structure material to the cathode having the second structure formed (second step).

First, the second structure may be formed on a part of the surface of the cathode surface as follows (first step).

That is to say, the second structure may be formed first by coating a second structure material including an oxygen ionic conductor, a mixed oxygen ionic-electronic conductor or a combination thereof on a part of the cathode surface. The cathode surface should not be entirely coated with the second structure material but be at least partly exposed for the formation of the first structure.

To coat the second structure material on the cathode surface, a slurry may be prepared by dispersing a powder of the second structure material (i.e., a powder of second structure material including an oxygen ionic conductor, a mixed oxygen ionic-electronic conductor or a combination thereof) in a solvent and the slurry may be coated on a part of the cathode surface.

As a non-limiting example, the second structure material may be coated in an amount of 1-20 wt % based on the cathode weight. If the amount of the second structure material is too large, the second structure material may block the pores inside the porous cathode, thereby inducing gas diffusion resistance and degrading electrode performance, and may also cover the entire cathode surface.

Alternatively, a cathode powder may be mixed with a powder of the second structure material to form the second structure. That is to say, after mixing the second structure material in powder state with the cathode powder, the second structure may be formed on a part of the cathode surface through sintering (specifically, in-situ sintering). Also in this case, the amount of the second structure material may be 1-20 wt % based on the cathode weight.

Then, the first structure may be formed by providing a molten carbonate electrolyte to the cathode having the second structure formed (second step).

As a non-limiting example, the first structure may be formed as follows. After loading a molten carbonate electrolyte powder in solid state in a channel of a matrix, an anode or a cathode, it is melted at the cell operation temperature. The resulting electrolyte solution moves toward the cathode owing to capillary pressure. Since first structure material is selected to have such a wettability that it does not cover the second structure material (solid) in liquid state, the molten carbonate electrolyte in liquid state can form the first structure on a part of the cathode surface without covering the second structure and exposing at least partly the surface of the second structure. At the operation temperature, the cathode structure having the first structure (molten carbonate electrolyte in liquid state) and the second structure (solid) are formed on the cathode surface. If the temperature is lowered below the melting temperature of the first structure material, i.e. the molten carbonate electrolyte, after the operation, the first structure becomes solid while maintaining the shape of the first structure and the second structure. That is to say, below the melting temperature and at room temperature, both the first structure and the second structure are in solid state.

In an embodiment of the present disclosure, by providing such a cathode structure, the site of electrochemical reactions occurring at the cathode, including oxygen reduction reaction, can be extended from the molten carbonate electrolyte film or membrane to the oxygen ionic conductor or mixed oxygen ionic-electronic conductor surface of the second structure. As a result, polarization resistance occurring at the cathode can be reduced and cell performance can be improved even at low operation temperatures (e.g., 500-600° C.).

Hereinafter, the present disclosure will be described in detail through test examples. However, the following test examples are for illustrative purposes only and do not limit the scope of the present disclosure.

### Test Example 1

As a mixed conductor exhibiting oxygen ionic conductivity and electronic conductivity, BYS (Bi_{1.5}Y_{0.3}Sm_{0.2}O₃) [ion transport constant to =0.9; Journal of Materials Science 36 1271-1276 (2001); non-patent document 4)] was prepared as follows.

Specifically, Bi(NO₃)₃.5H₂O, Y(NO₃)₃.5H₂O and Sm(NO₃)₃.6H₂O (Sigma Aldrich, analysis type) were dissolved in diluted nitric acid. After adding citric acid as a chelating agent at a ratio of 2:1, the resulting solution was heated while stirring.

The solution was stirred at 100° C. for 3 hours so that polymerization reaction occurred and then stirred further at 80° C. to obtain a transparent sol.

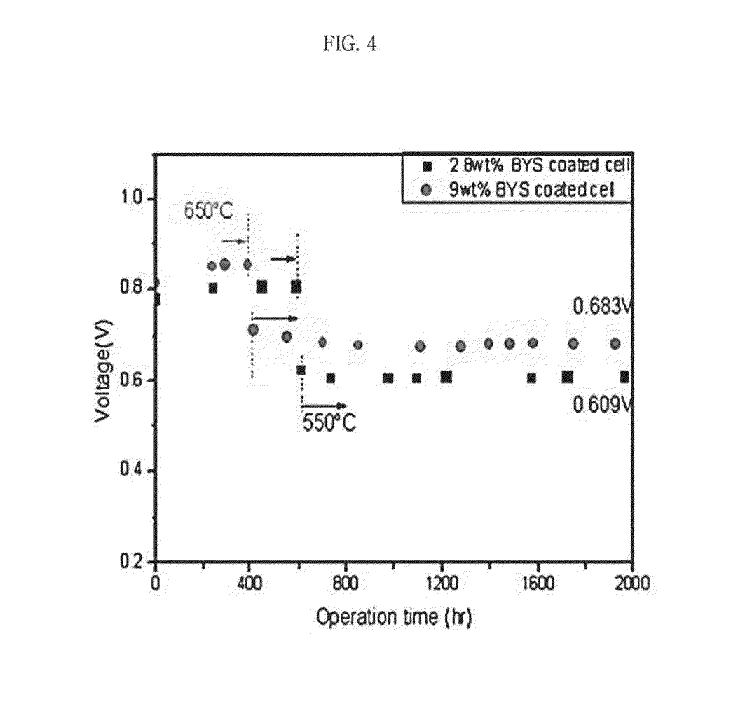

The sol was dried for a day in an oven dryer at 80° C. and then heat-treated at 400° C. in a sintering furnace. Thus obtained green powder was heat-treated at 800° C. for 3 hours. The resulting powder was identified as δ-phase BYS Bi_{1.5}Y_{0.3}Sm_{0.2}O₃ (BYS) by XRD analysis (see FIG. 4).

The BYS powder was dispersed in ethanol solution and ball milled for a day to control powder size uniformly to 1-2 μm.

The BYS powder was mixed with ethanol solution containing 3 wt % of a dispersing agent (BYK-190) and ultrasonicated for 30 minutes to obtain slurry for coating.

The BYS slurry solution was coated on a 10 cm×10 cm porous Ni (before oxidation to NiO) plate with an amount of 1-20 wt % based on the Ni cathode weight through infiltration and dried at 150° C. for 20 minutes to prepare a cathode. As a result, a BYS-coated structure (i.e., second structure) was formed on a part of the cathode surface. Since the drying temperature is not as high as to form a dense coating film through sintering of the BYS powder and since the amount of BYS is not enough to completely cover the cathode surface, the BYS coating is formed only on a part of the cathode surface.

The cathode was assembled with a matrix (α-lithium aluminate), a molten carbonate electrolyte (62 mol % Li₂CO₃:38 mol % K₂CO₃) and an anode (Ni-3 wt % Al) as a unit cell. The electrolyte was applied using a sheet tape-casted with the molten carbonate powder. At the operation temperature, the molten carbonate becomes liquid and moves toward the matrix, the anode and the cathode due to capillary pressure.

Oxidation and lithiation occur in situ at the operation temperature. As a result, the porous nickel turns into lithiated nickel oxide (NiO) and the cathode surface (including the inner surface) has a cathode structure as shown in FIG. 1A.

The molten carbonate fuel cell having the cathode structure was operated and its performance was evaluated.

As a comparative example, the same unit cell was prepared except for the BYS slurry coating. After oxidation and lithiation in situ, the molten carbonate fuel cell was operated and its performance was evaluated.

FIG. 3 shows a result of forming an electrode microstructure as shown in FIG. 1A using 0 wt %, 5.7 wt % and 9.5 wt % (based on Ni weight of cathode) of Bi_{1.5}Y_{0.3}Sm_{0.2}O₃ (hereinafter, BYS) as a mixed oxygen ionic-electronic conductor with poor wettability on a molten carbonate electrolyte on the inner surface of a molten carbonate fuel cell cathode and measuring the performance of a 100 cm² unit cell at different operation temperatures in Test Example 1 (power density measured at 650° C., 600° C. and 550° C. after operation at 650° C. for 288 hours; cathode, air:CO₂=70%:30%; anode, H₂:CO₂:H₂O=72%:18%:10%; oxygen and hydrogen utilization factor=40%).

As seen from FIG. 3, whereas the lithiated NiO electrode not coated with BYS exhibits a power density of 165 mW/cm² (or 90 mW/cm²) at 650° C. (or 550° C.) under the operation condition of air and hydrogen, the electrode having the second structure formed by coating 9.5 wt % of BYS on the inner surface of lithiated NiO based on Ni weight of the cathode exhibits a power density of 185 mW/cm² (132 mW/cm²) under the same condition.

FIG. 4 shows a result of forming an electrode microstructure as shown in FIG. 1A using 2.8 wt % (squares) or 9 wt % (circles) (based on Ni weight of cathode) of BYS as an oxygen ionic conductor or a mixed conductor with poor wettability on the inner surface of a molten carbonate fuel cell cathode and measuring the long-term performance of a 100 cm² unit cell for 2,000 hours at 550° C. under the current density of 150 mA/cm² in Test Example 1 (operation temperature=550° C.; cathode, air:CO₂=70%:30%; anode H₂:CO₂:H₂O=72%:18%:10%, oxygen and hydrogen utilization factor=40%).

As seen from FIG. 4, the long-term stability test result reveals that the cell can be operated stably for 2000 hours without degradation of performance. Accordingly, it can be seen that long-term stability is superior as compared to the previously known materials.

### Test Example 2

Bi(NO₃)₃.5H₂O and Sm(NO₃)₃.6H₂O (Sigma Aldrich, analysis type) were dissolved in diluted nitric acid. After adding citric acid as a chelating agent at a ratio of 2:1, the resulting solution was heated while stirring.

The solution was stirred at 100° C. for 3 hours so that polymerization reaction occurred and then stirred further at 80° C. to obtain a transparent sol.

The sol was dried for a day in an oven dryer at 80° C. and then heat-treated at 400° C. in a sintering furnace. Thus obtained powder was heat-treated at 800° C. for 3 hours to obtain δ-phase Bi_{1.8}Sm_{0.2}O₃ (BSO) powder as a mixed conductor. The BSO powder was dispersed in ethanol solution and ball milled for a day to control powder size uniformly to 1-2 μm.

In order to coat the BSO powder on the inner surface of a NiO cathode as shown in FIG. 1A, the BSO powder was mixed with ethanol solution containing 3 wt % of a dispersing agent (BYK-190) and ultrasonicated for 30 minutes to obtain slurry for coating.

The BSO slurry solution was coated on a 10 cm×10 cm porous Ni (before oxidation to NiO) plate with an amount of 10 wt % based on the Ni cathode weight through infiltration and dried at 150° C. for 20 minutes to prepare a cathode. As a result, a BSO-coated structure (i.e., second structure) was formed on a part of the cathode surface.

The cathode was assembled with a matrix (α-lithium aluminate), a molten carbonate electrolyte (62 mol % Li₂CO₃:38 mol % K₂CO₃) and an anode (Ni-3 wt % Al) as a unit cell.

The electrolyte was applied using a sheet tape-casted with the molten carbonate powder. At the operation temperature, the molten carbonate becomes liquid and moves toward the matrix, the anode and the cathode due to capillary pressure.

Oxidation and lithiation occur in situ at the operation temperature. As a result, the porous nickel turns into lithiated nickel oxide (NiO) and the cathode surface (including the inner surface) has a cathode structure as shown in FIG. 1A.

The molten carbonate fuel cell having the cathode structure was operated and its performance was evaluated.

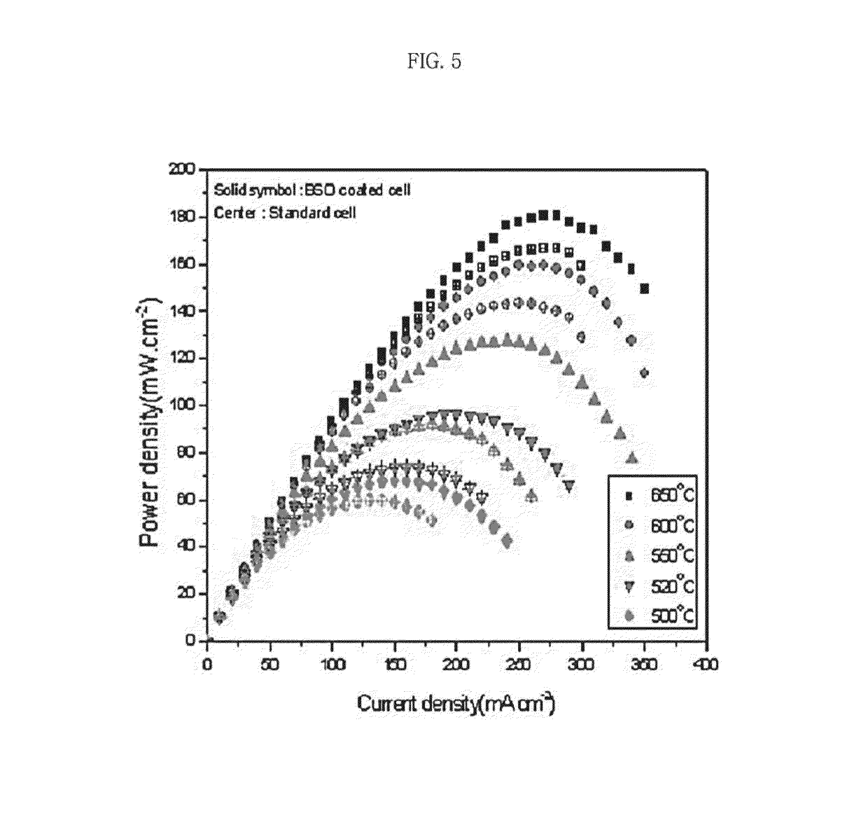

FIG. 5 shows a result of forming an electrode microstructure as shown in FIG. 1A using 10 wt % (based on Ni weight of cathode) of Bi_{1.8}Sm_{0.2}O₃ (BSO) as a mixed oxygen ionic-electronic conductor with poor wettability on a molten carbonate electrolyte on the inner surface of a molten carbonate fuel cell cathode and measuring the performance of a 100 cm² unit cell at different operation temperatures in Test Example 2 (power density measured at 650° C., 600° C., 550° C., 520° C. and 500° C. after operation at 650° C. for 288 hours; cathode, air:CO₂=70%:30%; anode, H₂:CO₂:H₂O=72%:18%:10%; oxygen and hydrogen utilization factor=40%).

In FIG. 5, the solid symbols represent the BSO-coated electrode and the symbols having crosses at the center represent the general lithiated NiO electrode (standard cell).

As seen from FIG. 5, whereas the lithiated NiO electrode not coated with BSO exhibits a power density of 165 mW/cm² (or 90 mW/cm²) at 650° C. (or 550° C.) under the operation condition of air and hydrogen, the electrode having 10 wt % of BSO coated on the inner surface of lithiated NiO exhibits a power density of 180 mW/cm² (123 mW/cm²) under the same condition.

[Measurement of Solubility of BYS Powder and BSO Powder Used in Test Examples 1 and 2]

In order to investigate the solubility of the BYS powder used in Test Example 1 and the BSO powder used in Test Example 2, the BYS powder and the BSO powder were immersed in 62 mol % Li₂CO₃:38 mol % K₂CO₃ molten carbonate under the atmosphere of air:CO₂=70%:30% for at least 100 hours (out-of-cell test) and the bismuth concentration in the electrolyte was analyzed by ICP/AAS 36 hours and 422 hours later (see Table 1). For comparison, ICP analysis was made also for bismuth oxide (Bi₂O₃).

TABLE 1

| | Immersion | Bismuth (Bi) concentration |
|---|---|---|
| Sample | time (hr) | in electrolyte (ppm) |
| Bi₂O₃ | 36 hr | 134 |
| | 422 hr | 450 |
| BYS | 36 hr | 110 |
| | 422 hr | 330 |
| BSO | 36 hr | 126 |
| | 422 hr | 313 |

*Analysis method: ICP/AAS

As seen from [Table 1], the ICP measurement result shows that about 0.2 mol % or less of BYS or BSO is dissolved in the 62 mol % Li₂CO₃:38 mol % K₂CO₃ molten carbonate at 650° C. under the atmosphere of air:CO₂=70%:30%.

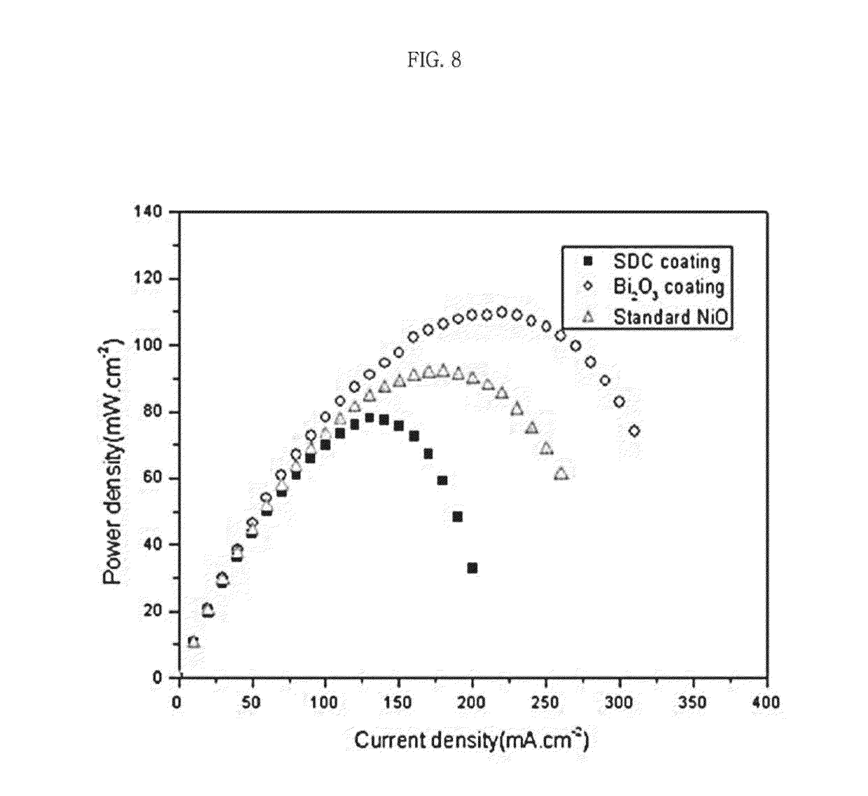

In order to form the second structure according to the present disclosure, the second structure material needs to be not dissolved in the molten carbonate of the first structure. For this, doping may be conducted. For example, in order to lower the solubility of Bi₂O₃, doped bismuth oxide, e.g., BYS, i.e. Y- and Sm-doped bismuth oxide, or BSO, i.e., Sm-doped bismuth oxide, may be used as described above (in this case, the solubility in the molten carbonate electrolyte becomes 30% or less as compared to Bi₂O₃ alone). As a result, the performance of the cathode coated with the doped bismuth oxide is much superior to Bi₂O₃ because of high oxygen ionic conductivity and phase stability (see FIG. 4 and FIG. 8).

To conclude, the doped cathode exhibits lower solubility for the molten carbonate as well as better electrode performance and long-term performance as compared to Bi₂O₃ alone.

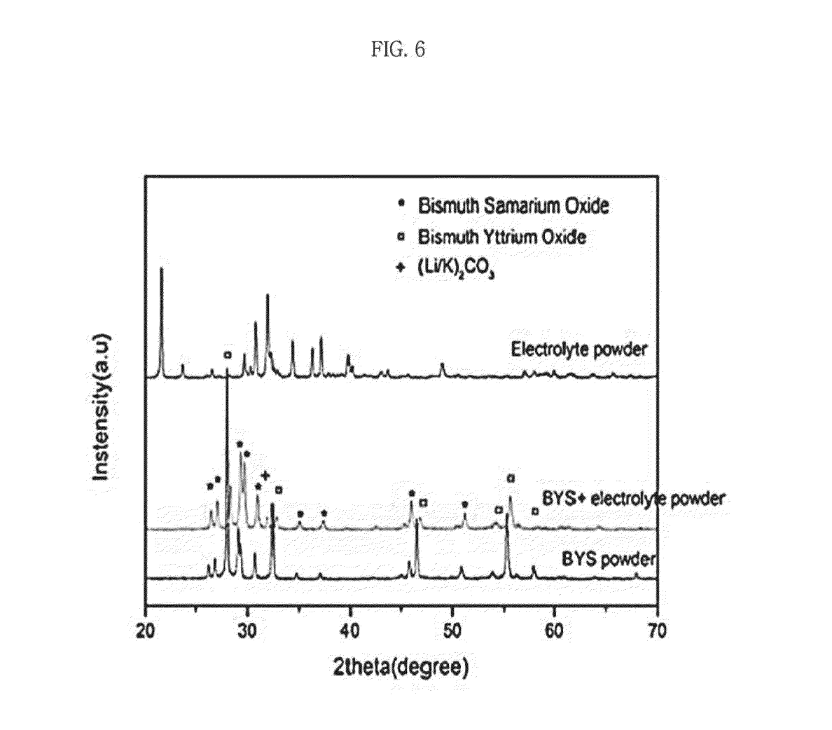

FIG. 6 shows a result of analyzing phase change by XRD after immersing BYS powder in 62 mol % Li₂CO₃:38 mol % K₂CO₃ molten carbonate under the atmosphere of air:CO₂=70%:30% for at least 100 hours (out-of-cell test) in order to investigate the phase stability of the BYS powder used in Test Example 1 in a molten carbonate electrolyte.

As seen from FIG. 6, the XRD analysis result of the BYS powder that had been immersed in the 62 mol % Li₂CO₃:38 mol % K₂CO₃ molten carbonate at room temperature shows that δ-phase bismuth is maintained well.

### Test Example 3

PbO (Sigma Aldrich, purity=99.9%, particle size=1-2 μm), which is a non-oxygen ionic conductor but exhibits poor wettability for the molten carbonate electrolyte (see FIG. 2C), was coated on a NiO cathode in the same manner as in Test Example 1.

A cathode was prepared by coating PbO on a 10 cm×10 cm porous Ni plate with an amount of 10 wt % based on the Ni cathode weight as in Test Examples 1-2. The cathode was assembled with a matrix, an electrolyte and an anode as a unit cell. After oxidation and lithiation in situ at the operation temperature, the cell was operated and its performance was evaluated.

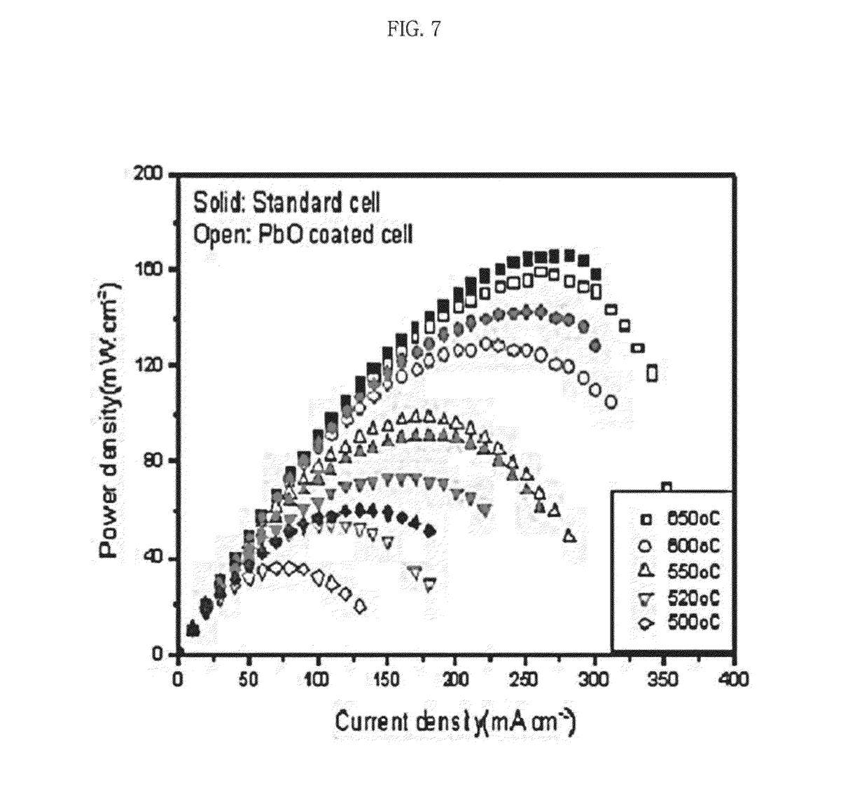

FIG. 7 shows a result of forming an electrode microstructure as shown in FIG. 1A using 10 wt % (based on Ni weight of cathode) of PbO as a non-oxygen ionic conductor or a non-mixed conductor with poor wettability on a molten carbonate electrolyte on the inner surface of a molten carbonate fuel cell cathode and measuring the performance of a 100 cm² unit cell at different operation temperatures in Test Example 3 (power density measured at 650° C., 600° C. and 550° C. after operation at 650° C. for 100 hours; cathode, air:CO₂=70%:30%; anode, H₂:CO₂:H₂O=72%:18%:10%; oxygen and hydrogen utilization factor=40%).

In FIG. 7, the solid symbols represent the general lithiated NiO electrode (standard cell) and open symbols represent the PbO-coated electrode.

As seen from FIG. 7, the unit cell having the cathode with the second structure formed by coating with PbO exhibits lower performance in the temperature range of 500-650° C. as compared to the unit cell prepared only with the lithiated nickel oxide (NiO) electrode (standard cell).

Accordingly, it can be seen that, to provide an additional site for the electrochemical reactions described in FIG. 1A, [Reaction Formula 1] and [Reaction Formula 2] different from the first structure, an oxygen ionic conductor or a mixed oxygen ionic-electronic conductor with poor wettability has to be used.

### Test Example 4

Sm_{0.2}Ce_{0.8}O₂ (SDC; Praxair, purity=99.9%, particle size<1 μm, ion transport constant to =0.8), which is an oxygen ionic conductor but exhibits good wettability for the molten carbonate electrolyte (see FIG. 2D), was coated on a NiO cathode in the same manner as in Test Example 1.

A cathode was prepared by coating SDC on a 10 cm×10 cm porous Ni plate with an amount of 10 wt % based on the Ni cathode weight as in Test Examples 1-2. The cathode was assembled with a matrix, an electrolyte and an anode as a unit cell. After oxidation and lithiation in situ at the operation temperature, the cell was operated and its performance was evaluated.

FIG. 8 shows a result of forming an electrode microstructure as shown in FIG. 1A using 10 wt % (based on Ni weight of cathode) of SDC as an oxygen ionic conductor or a mixed conductor with good wettability on a molten carbonate electrolyte on the inner surface of a molten carbonate fuel cell cathode and measuring the performance of a 100 cm² unit cell at different operation temperatures in Test Example 4 (power density measured at 550° C. as compared to the existing NiO electrode cell and a Bi₂O₃-coated electrode cell (power density measured at 550° C. after operation for 100 hours; cathode, air:CO₂=70%:30%; anode, H₂:CO₂:H₂O=72%:18%:10%; oxygen and hydrogen utilization factor=40%).

In FIG. 8, the squares represent the SDC-coated electrode, the triangles represent the general lithiated NiO electrode (standard cell), and the circles represent the Bi₂O₃-coated electrode.

As seen from FIG. 8, the unit cell having the cathode with the second structure formed by coating with SDC exhibits comparable or slightly lower performance in the temperature range of 500-650° C. as compared to the unit cell prepared only with the lithiated nickel oxide (NiO) electrode.

Accordingly, it can be seen that, since an electrode microstructure as shown in FIG. 1B is formed when an oxygen ionic conductor with good wettability is coated on the cathode, electrochemical reactions occur only on the electrolyte and no improvement in cathode polarization or cell performance is achieved as in BYS.

### Test Example 5

Pure bismuth oxide is known to exist in various phases depending on the heat-treating temperature. Generally, it is known that the α-phase which is a p-type conductor is stable at temperatures of 750° C. or lower and the δ-phase which is an oxygen ionic conductor is stable at temperatures of 750° C. or higher.

However, the α-phase and the δ-phase exist together at the molten carbonate fuel cell operation temperature range of 550-650° C.

Accordingly, pure bismuth oxide (Bi₂O₃) exhibits lower oxygen ionic conductivity than BYS or doped bismuth oxide. However, since it has a wetting angle (0) of about 61° at 600° C. under the condition of air:CO₂=7:3, a microstructure as in FIG. 1A can be formed.

Pure bismuth oxide was coated on a NiO cathode in the same manner as in Test Example 1.

A cathode was prepared by coating pure bismuth oxide (Bi₂O₃) on a 10 cm×10 cm porous Ni plate with an amount of 10 wt % based on the Ni cathode weight as in Test Examples 1-2. The cathode was assembled with a matrix, an electrolyte and an anode as a unit cell. After oxidation and lithiation in situ at the operation temperature, the cell was operated and its performance was evaluated.

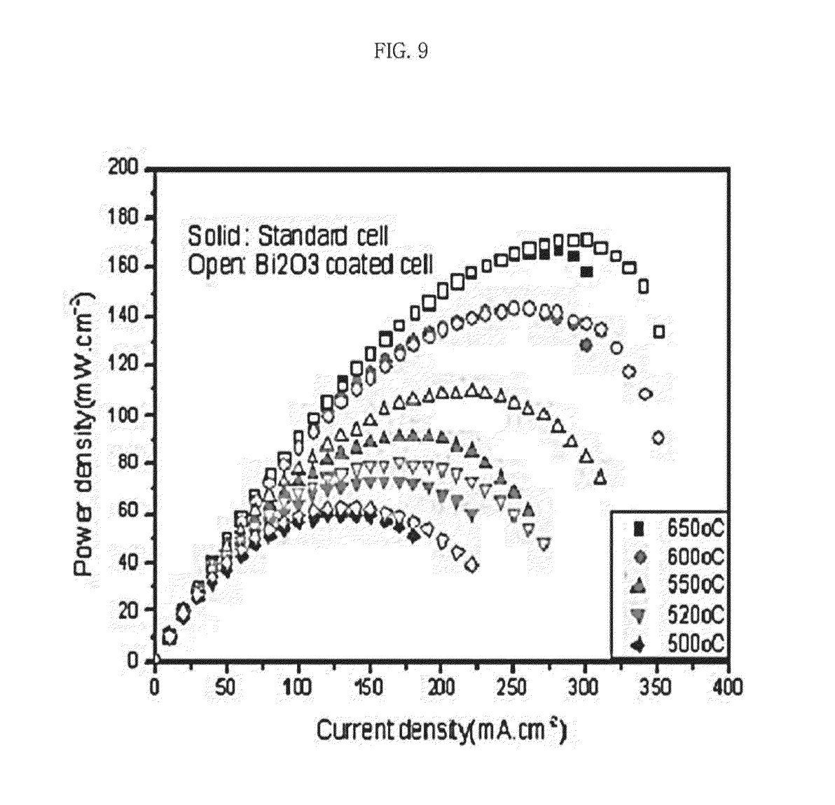

FIG. 9 shows a result of forming an electrode microstructure as shown in FIG. 1A using 10 wt % (based on Ni weight of cathode) of pure bismuth oxide as an oxygen ionic conductor or a mixed conductor with poor wettability on a molten carbonate electrolyte in a molten carbonate fuel cell cathode and measuring the performance of a 100 cm² unit cell at different operation temperatures in Test Example 5 (power density measured at 650° C., 600° C. and 550° C. after operation at 650° C. for 100 hours; cathode, air:CO₂=70%:30%; anode, H₂:CO₂:H₂O=72%:18%:10%; oxygen and hydrogen utilization factor=40%).

In FIG. 9, the solid symbols represent the general lithiated NiO electrode (standard cell) and the open symbols represent the Bi₂O₃-coated electrode.

As seen from FIG. 9, although the unit cell having the cathode with the second structure formed by coating with pure bismuth oxide exhibits better performance in the temperature range of 500-650° C. as compared to the unit cell prepared only with the lithiated nickel oxide (NiO) electrode, it exhibits about 20 mW/cm² lower power density at 550° C. as compared to the BYS-coated electrode exhibiting high oxygen ionic conductivity under the same condition (see FIG. 3). This may be because BYS allows faster oxygen ion transport according to [Reaction Formula 2] as compared to pure bismuth oxide.

What is claimed is:

1. A cathode for a molten carbonate fuel cell,
wherein
a first structure and a second structure are formed on the cathode,
a surface of the second structure is exposed at least partly without being covered by a material of the first structure,
the first structure comprises a molten carbonate electrolyte,
the second structure comprises an oxygen ionic conductor, a mixed oxygen ionic-electronic conductor or a combination thereof,
the first structure provides a first electrochemical reaction site, and
the second structure whose surface is exposed at least partly without being covered by the first structure provides a second electrochemical reaction site which is different from the first electrochemical reaction site provided by the first structure.

2. The cathode for a molten carbonate fuel cell according to claim 1, wherein the first structure is in contact with the second structure.

3. The cathode for a molten carbonate fuel cell according to claim 2, wherein a reaction according to [Reaction Formula 1] occurs in a portion where the first structure is in contact with the second structure and a reaction according to [Reaction Formula 2] occurs in a portion of the second structure exposed without being in contact with the first structure:
CO₂+O²⁻→CO₃²⁻ [Reaction Formula 1]
½O₂+2e⁻→O²⁻ [Reaction Formula 2]

4. The cathode for a molten carbonate fuel cell according to claim 1, wherein a first structure material and a second structure material are selected such that the first structure material in liquid state does not cover the second structure material in solid state under a condition of an operation temperature and cathode atmosphere of a molten carbonate fuel cell.

5. The cathode for a molten carbonate fuel cell according to claim 1, wherein the first structure material in liquid state has a wetting angle (θ) of 20-90° on the second structure material in solid state under a condition of 500-650° C. and atmosphere of air:CO₂=70%:30%.

6. The cathode for a molten carbonate fuel cell according to claim 5, wherein the wetting angle (θ) is 50-90°.

7. The cathode for a molten carbonate fuel cell according to claim 6, wherein the wetting angle (θ) is 60-90°.

8. The cathode for a molten carbonate fuel cell according to claim 1, wherein the first structure material is Li—K molten carbonate electrolyte, Li—Na molten carbonate electrolyte or Li—K—Na molten carbonate electrolyte.

9. The cathode for a molten carbonate fuel cell according to claim 1, wherein the second structure consists essentially of a mixed oxygen ionic-electronic conductor.

10. The cathode for a molten carbonate fuel cell according to claim 1, wherein the second structure comprises a bismuth oxide composition comprising bismuth oxide, doped bismuth oxide or a combination thereof.

11. The cathode for a molten carbonate fuel cell according to claim 1, wherein the second structure comprises doped bismuth oxide.

12. The cathode for a molten carbonate fuel cell according to claim 1, wherein the second structure comprises a composition comprising Bi₂O₃-MO (wherein M is one or more selected from a group consisting of Ca, Sr, Ba and Cu), Bi₂O₃-MO₂ (wherein M is one or more selected from a group consisting of Ti, Zr and Te), Bi₂O₃-MO₃ (wherein M is one or more selected from a group consisting of W and Mo), Bi₂O₃-M₂O₅ (wherein M is one or more selected from a group consisting of V, Nb and Ta), Bi₂O₃-M₂O₃ (wherein M is one or more selected from a group consisting of La, Sm, Y, Gd and Er) or a combination thereof.

13. The cathode for a molten carbonate fuel cell according to claim 1, wherein the cathode is a porous lithiated nickel oxide cathode.

14. A method for preparing a cathode for a molten carbonate fuel cell, comprising:
forming a first structure and a second structure on the cathode,
wherein
the first structure comprises a molten carbonate electrolyte,
the second structure comprises an oxygen ionic conductor, a mixed oxygen ionic-electronic conductor or a combination thereof,
a surface of the second structure is exposed at least partly without being covered by the first structure,
the first structure provides a first electrochemical reaction site, and
the second structure whose surface is exposed at least partly without being covered by the first structure provides a second electrochemical reaction site which is different from the first electrochemical reaction site provided by the first structure.

15. The method for preparing a cathode for a molten carbonate fuel cell according to claim 14, wherein the method comprises:
forming the second structure on a part of a surface of the cathode; and
forming the first structure by providing a molten carbonate electrolyte as a first structure material to the cathode having the second structure formed.

16. The method for preparing a cathode for a molten carbonate fuel cell according to claim 15, wherein the second structure is formed by coating a second structure material comprising an oxygen ionic conductor, a mixed oxygen ionic-electronic conductor or a combination thereof partly on a surface of the cathode.

17. The method for preparing a cathode for a molten carbonate fuel cell according to claim 15, wherein the second structure is formed partly on a surface of the cathode by mixing a second structure material powder comprising an oxygen ionic conductor, a mixed oxygen ionic-electronic conductor or a combination thereof with a cathode material powder and sintering the same.

18. The method for preparing a cathode for a molten carbonate fuel cell according to claim 15, wherein the first structure is formed by providing a molten carbonate electrolyte in solid state to the cathode having the second structure formed and operating the molten carbonate fuel cell comprising the cathode at an operation temperature to melt the molten carbonate electrolyte in solid state into liquid state, and a wettability of the molten carbonate electrolyte in liquid state on the second structure material in solid state is controlled such that the molten carbonate electrolyte in liquid state does not cover the second structure material in solid state.

19. The method for preparing a cathode for a molten carbonate fuel cell according to claim 18, wherein the second structure is formed by coating a slurry in which a second structure material powder comprising an oxygen ionic conductor, a mixed oxygen ionic-electronic conductor or a combination thereof is dispersed in a solvent partly on a surface of a porous nickel cathode, the first structure is formed by providing a molten carbonate electrolyte in solid state to the porous nickel cathode having the second structure formed and operating the molten carbonate fuel cell comprising the cathode at an operation temperature, and the porous nickel cathode is transformed into a porous lithiated nickel oxide cathode.

20. A method for improving a performance of a cathode for a molten carbonate fuel cell, comprising:
forming a first structure and a second structure on the cathode,
wherein
the first structure comprises a molten carbonate electrolyte,
the second structure comprises an oxygen ionic conductor, a mixed oxygen ionic-electronic conductor or a combination thereof,
controlling a wettability of a first structure material in liquid state on a second structure material in solid state such that a surface of the second structure is exposed at least partly without being covered by the first structure,
wherein
the first structure provides a first electrochemical reaction site, and
the second structure whose surface is exposed at least partly without being covered by the first structure provides a second electrochemical reaction site which is different from the first electrochemical reaction site provided by the first structure.
